(19) United States
(12) Patent Application Publication
(10) Pub. No.: US 2011/0035450 A1
(43) Pub. Date: Feb. 10, 2011

(54) MESSAGE-BASED COMMUNICATION SYSTEM MONITOR

(76) Inventors: Philip Mathuis, Asse (BE); Philippe Geleyn, Bruxelles (BE)

Correspondence Address: CHRISTIE, PARKER & HALE, LLP, PO BOX 7068, PASADENA, CA, 91109-7068, US

(21) Appl. No.: 12/918,319

(22) PCT Filed: Aug. 27, 2009
(86) PCT No.: PCT/IB09/05051

§ 371 Date: Oct. 27, 2010

(30) Foreign Application Priority Data
Feb. 19, 2008 (FR) 0800877

(51) Int. Cl. G06F 15/16

(52) U.S. Cl. 709/205

(57) ABSTRACT

A device for exchanging documents between two parties through a network comprises: an interface (13) arranged for receiving transmitter document data (16) coming from the network and including at least a transmitter identifier and an addressee identifier, a converter (15) capable of converting transmitter document data (16) into intermediate document data (18) on the basis of a transmitter model associated with the transmitter identifier of the transmitter document data (16), while keeping the transmitter identifier and the addressee identifier, a generator (20) capable of converting intermediate document data (18) on the one hand into addressee document data (22) on the basis of an addressee model associated with the addressee identifier of the intermediate document data (18), and on the other hand into archive document data (24), and a controller (14) arranged for calling the generator (20) with the resulting intermediate document data, and for storing the resulting archive document data for later access by the transmitter or the addressee.

The invention relates to the communication of documents between parties connected by a wide area network such as the Internet.

During transactions, parties often need to share a transaction document between them. Generally, the parties each have their own computer information system, and the systems are mutually incompatible.

In order to remedy this, it is therefore necessary to print the document and to send it by mail or by fax, and for each side to recapture relevant information in their respective computer information systems.

This method is inefficient, slow, less secure than transport by an electronic network, and imposes a considerable logistics whose financial and ecological consequences are worrying for modern businesses.

The invention is going to improve the situation.

To that end, the invention proposes a device for exchanging documents between two parties through a network, which device comprises an interface arranged for receiving transmitter document data coming from the network and including at least a transmitter identifier and an addressee identifier.

The device also comprises a converter capable of converting transmitter document data into intermediate document data on the basis of a transmitter model associated with the transmitter identifier of the transmitter document data, while keeping the transmitter identifier and the addressee identifier.

It further comprises a generator capable of converting intermediate document data on the one hand into addressee document data on the basis of an addressee model associated with the addressee identifier of the intermediate document data, and on the other hand into archive document data.

Finally, the device comprises a controller arranged for calling the converter with transmitter document data received by the interface, for calling the generator with the resulting intermediate document data, and for storing the resulting archive document data for later access by the transmitter or the addressee.

Such a device is particularly valuable because it permits the secure and efficient management of the exchange of documents between parties having computer information systems and formats with little or no compatibility.

Management is wholly electronic, which is quicker, less costly and more ecological than paper- and capture-based solutions.

Moreover, the addressee document data can be adapted for direct processing by the addressee party's computer information system. This is more efficient in terms of logistics and organization.

Finally, within the context of financial transaction documents, operation of the device by a trusted third party can permit improved dispute resolution, especially by virtue of the archive document data.

The invention relates also to a method of exchanging documents between two parties through a network, which method comprises:

a) the sending by one party of transmitter document data to an exchange device through the network,
b) the receipt in the exchange device of the transmitter document data, which include at least a transmitter identifier and an addressee identifier,
c) the conversion, in the exchange device, of the transmitter document data into intermediate document data on the basis of a transmitter model associated with the transmitter identifier of the transmitter document data, while keeping the transmitter identifier and the addressee identifier,
d) the conversion, in the exchange device, of the intermediate document data into addressee document data on the basis of an addressee model associated with the addressee identifier of the intermediate document data, the addressee document data to the addressee, and
e) the conversion, in the exchange device, of the intermediate document data into archive document data, and storage of the archive document data in the exchange device, and
f) the sending, by the exchange device, of the addressee document data to the addressee.

Other features and advantages of the invention will better become apparent upon reading the following description, which is taken from examples given by way of illustration and without implying any limitation from the drawings, in which:

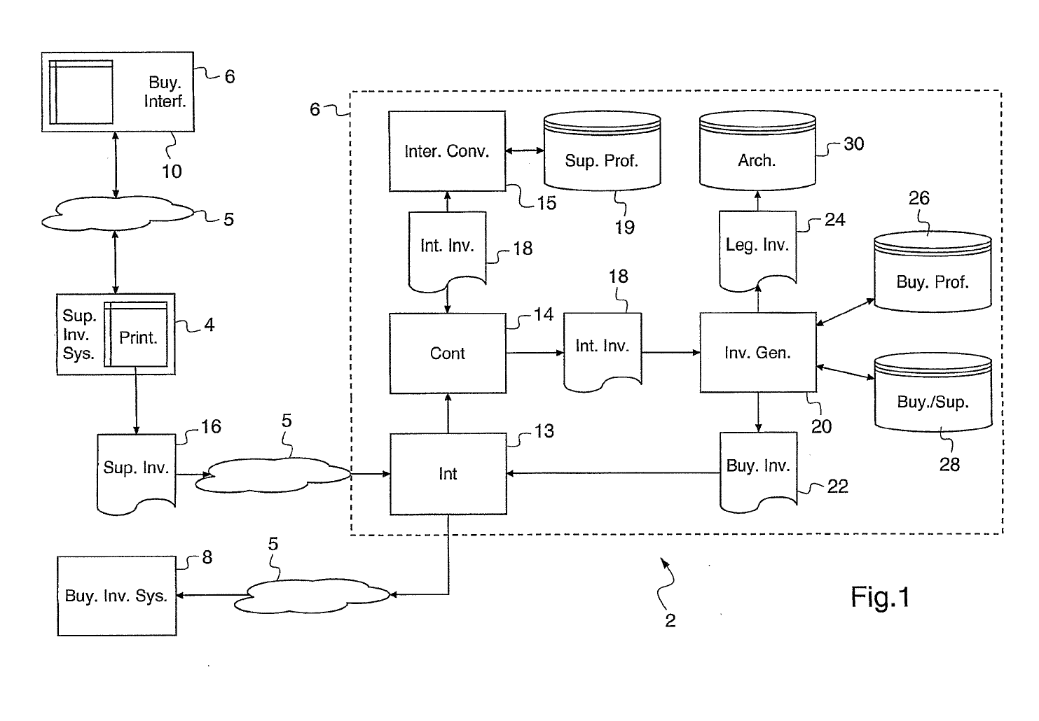

FIG. 1 shows a schematic view of a device according to the invention, and of an example of a data flow between two parties;

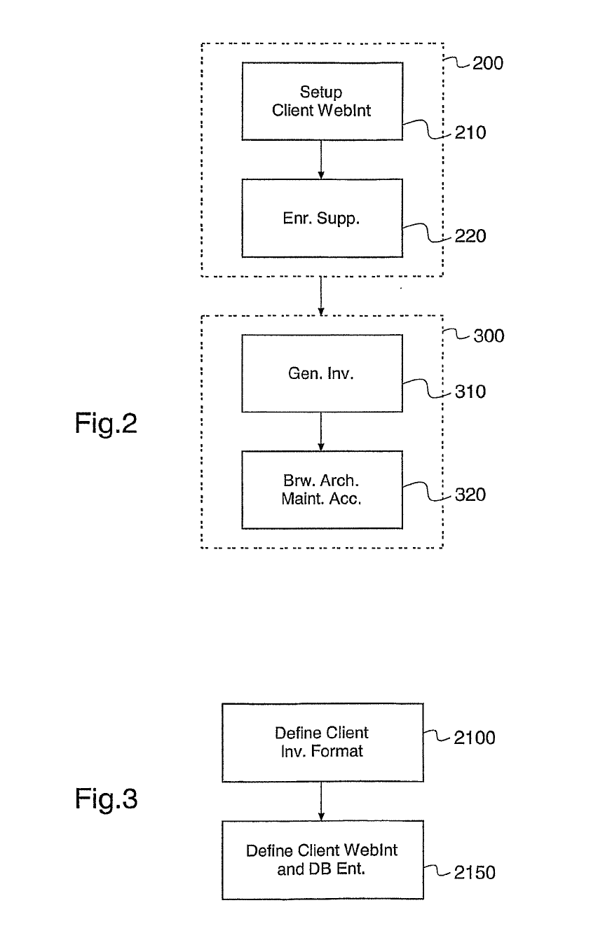

FIG. 2 shows an implementation diagram of the device of FIG. 1;

FIG. 3 shows a particular implementation of a first operation of FIG. 2;

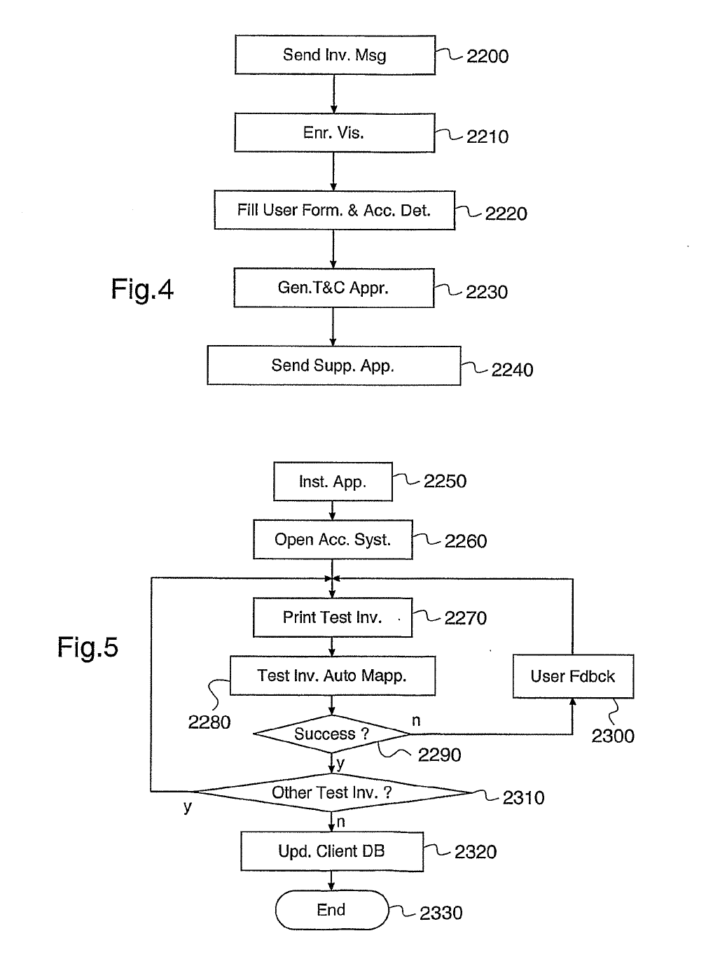

FIG. 4 shows part of a particular implementation of a second operation of FIG. 2;

FIG. 5 shows another part of a particular implementation of the second operation of FIG. 2; and

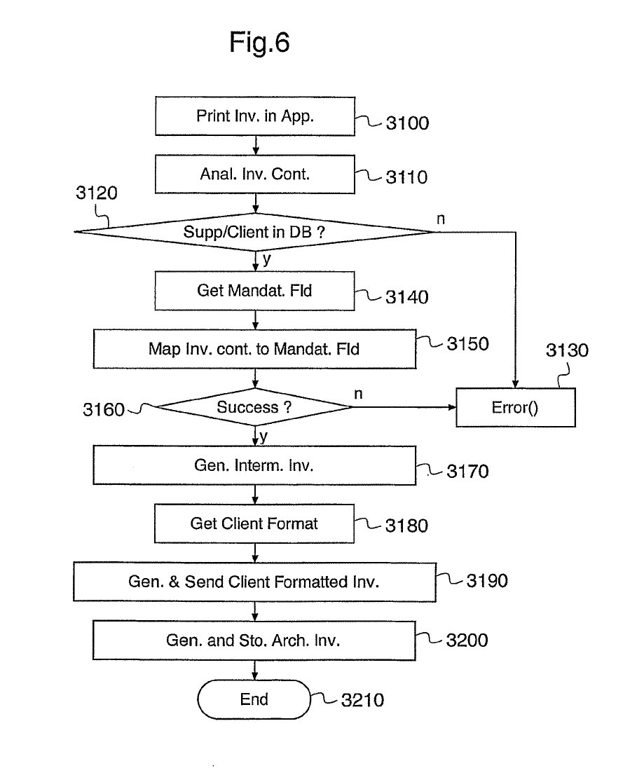

FIG. 6 shows a particular implementation of a third operation of FIG. 2.

The drawings and the description hereinbelow substantially contain elements of a certain nature. They may therefore not only serve better understanding of the present invention but also contribute towards the definition thereof, where appropriate.

In modern businesses, the different departments, such as production, sales, purchases, accounts and others, are connected by way of computer programs generally designated by the expression computer information system.

Accordingly, control of the activity and daily operation of such businesses is based on those systems and their reliability. Within the context of sales and purchasing operations, numerous difficulties arise owing to the number of distinct computer information systems between parties and the absence or lack of interoperability thereof.

To that end, it is frequently necessary to re-capture entire documents such as invoices or purchase orders, which gives rise to considerable losses of time and resources.

On the other hand, the problems mentioned above are even more acute in the case of transactions in which a paper version and/or authentication are necessary to ensure the validity of the transaction.

In such cases, the computer information systems are generally incapable of receiving a document from a third party and carrying out the necessary authentication. Although developments may exist for permitting such exchanges, these developments are extremely limited and are restricted to only the situations for which they have been created.

FIG. 1 shows an environment 2 in which a transmitter and an addressee exchange transaction documents, such as orders or invoices.

The environment 2 comprises a transmitter system 4, an exchange device 6 and an addressee system 8, which communicate with one another by way of a network 5.

The network 5 can be any type of known network, although the invention can be used particularly with a network of the Internet type.

In a variant, the transmitter system 4 and the exchange device 6 can be connected by a first type of network, and the exchange device 6 and the addressee system 8 can be connected by a different type of network.

The transmitter system 4 is a computer information system disposed with the party participating in the transactions who transmits the documents to be exchanged. The transmitter system 4 can be a terminal connected to the transmitter's computer information system, or it can be a single station decoupled from the transmitter's other computer components.

The transmitter system 4 can include software which is naturally executed on a computer, or a Web application which is executed remotely by the transmitter, or any other type of application permitting the generation of a document which the transmitter wishes to exchange with the addressee.

In general, it must be understood that the transmitter system 4 is a software or hardware component which is arranged to produce a document which the transmitter wishes to exchange in a type and a format which are specific to him.

The transmitter system 4 comprises a network interface which allows it to connect to the Internet or to any other network which will be suitable for communication between the transmitter system 4, the exchange device 6 and the addressee system 8.

The addressee system 8 is functionally very similar to the transmitter system 4, in that it can be produced substantially in the same manner.

The main difference between the transmitter system 4 and the addressee system 8 resides in their role in the exchange, that is to say one is the originator of the exchange (the transmitter system 4) and the other is the recipient of the exchange (the addressee system 8).

However, those roles can be reversed as a function of the exchange in question:
within the context of an order, one party, who wishes to receive products, will be the transmitter system 4 and the other party, who is to produce the products, will be the addressee system 8;
within the context of invoicing, the party who was previously the transmitter system may this time be the addressee system, and vice versa.

Owing to the high degree of integration of the hardware components in modern information systems, the exchange device 6 allows a strong link to be created between parties who regularly exchange products or services, while simplifying and automating the processes which are associated with such exchanges.

The device 6 comprises two main parts:
a portal 10, the role of which will be explained hereinbelow; and
an exchange processing unit 12.

The exchange processing unit 12 comprises a network interface 13 which allows it to communicate with the transmitter system 4 and the addressee system 8 as defined hereinbefore.

The network interface is connected at the input to a controller 14. The controller 14 manages the data flow in the exchange unit 12 and calls a converter 15 on receipt of a transmitter document 16 coming from the transmitter system 4.

The function of the converter 15 is to receive the transmitter document 16 at the input, following an operation by the transmitter system 4, and to convert it into an intermediate document 18, the structure of which is specific to the exchange device 6.

The converter 15 operates on the basis of a storage device 19 which contains description data of the transmitter documents 16. The storage device 19 will be described in greater detail hereinbelow.

The intermediate document 18 can be saved in XML format. This format permits increased integration in modern networks. Other formats can, of course, be envisaged.

Once the transmitter document 16 has been converted into an intermediate document 18, the controller 14 transmits it to a generator 20. The purpose of the generator 20 is to generate a plurality of documents, including an addressee document 22 and an archive document 24.

The generator 20 operates on the basis of storage devices 26 and 28 which contain description data of the addressee documents 22 and the archive documents 24. The storage devices 26 and 28 will be described in greater detail hereinbelow.

The converter 15 and the generator 20 can be produced in the form of a program executed locally or remotely, or in the form of specialized circuits such as ASICs, or with other suitable integrated circuits.

In an advantageous embodiment, the generator 20 comprises a signature module which authenticates the archive document 24 for archiving in a storage device 30.

The signature can be produced by any means known to the person skilled in the art, by means of either software or hardware. An example is temporal marking of the document.

The storage devices 19, 26, 28 and 30 can be in the form of tables or of databases which can be physically stored on the same support or in different locations and supports. These storage devices can also be distributed, and be wholly or partially located on remote storage devices.

Although they have been shown in the same box 12 in FIG. 1, it will be understood that the controller 14, the converter 15 and the generator 20 can be produced on separate computers which are combined in the exchange unit 12, or on a single machine.

FIG. 2 shows a general diagram of the use of the exchange device 6 in the environment 2.

The implementation of the exchange device 6 comprises two main operations:
in an operation 200, exchange between the addressee and the transmitter begins with a preparation operation,
in an operation 300, the addressee and the transmitter use the exchange device 6 to exchange documents.

Operation 200 comprises an operation 210 in which the addressee prepares the portal 10. The portal 10 serves as a tool for the registration of transmitters in relation with the addressee, as well as for the management of exchanges.

The portal 10 can be personalized in order to correspond with the addressee's graphic themes and in order to contain information elements relating to the addressee and to the functioning of document exchanges using the exchange device 6 for new transmitters.

An operation 220 is then carried out, in which the addressee invites transmitters to exchange documents with him by way of the exchange device 6.

In the embodiment described here, operation 220 comprises:
a registration operation, in which a new transmitter or an existing transmitter register on the portal 10 in order to be connected to the addressee and be able to send documents to him. This operation is shown by way of example in FIG. 4.
an installation operation, in which a transmitter installs a software element for connection to the exchange device 6, and executes a series of operations for controlling his exchange with the addressee. This operation is shown by way of example in FIG. 5.

Operation 300 comprises an operation 310 of sending documents and an operation 320 of archive consultation and account maintenance. These two operations can be carried out in parallel and are complementary.

Operation 310 is shown by way of example in FIG. 6. Operation 320 is a generic operation which allows the addressee and the transmitter to amend details of their accounts, to obtain exchange credits when necessary, and to consult the exchanges in which they are involved. Other typical account management/maintenance functions may be associated with operation 320.

FIG. 3 shows a particular form of operation 210. Operation 210 can be carried out by combining an operation 2100 and an operation 2200. Operations 2100 and 2200 can be carried out sequentially or in parallel, as the person skilled in the art will know.

In operation 2100, the addressee defines an addressee document format. The addressee document format forms a model which is stored in the storage device 26 and which is used by the generator 20 to prepare the addressee document 22.

Inter alia, that model can be chosen to correspond to the format of the addressee's computer information system, so that the computer information system of the addressee system 8 can directly integrate and use the addressee document 26.

Optionally, the addressee can also define in the model any information he considers necessary for the exchange. As will be seen hereinbelow, in the absence of that information, the exchange can be blocked.

This enables the robustness of the device of the invention to be improved because it is thus ensured that a certain number of data critical to the characterization of the exchange are successfully transmitted.

Examples of such information can be codes specific to the addressee, allowing a connection to be made with his computer information system, data specific to the addressee or to the transmitter, etc.

In operation 2150, the addressee defines the portal 10 as mentioned above. Once the portal 10 has been defined, the addressee is able to send invitations to transmitters with whom he wishes to exchange documents, by e-mail or by any other appropriate means of communication.

At the end of operation 2150, the storage device 28 is modified to take account of the preceding operations, so that a transmitter can subsequently be associated with the addressee.

FIG. 4 shows a particular form of the registration operation of operation 220.

In this form, a transmitter begins at 2200 with an invitation received from the addressee. The invitation may have been sent by e-mail or by any other means of communication, in collaboration with the portal 10 or not.

The concrete form of the invitation 2200 is a visit at 2210 to the portal 10. This visit can be carried out by consultation of a web page associated with the portal 10 or by connection to any site or other media in connection with the portal 10 which allows the transmitter to record a relation with the addressee.

If the transmitter has never used the exchange device 6, registration begins with the entry of several details concerning his business, such as the name, domicile, VAT number, company trade registration number, other specific mentions linked to the addressee, etc. (operation 2220).

Then, or if the transmitter has already used the exchange device 6, he merely has to enter his account identifiers and the transmitter is directed to a subscription operation 2230.

The purpose of the subscription operation 2230 is to register the subscription of the transmitter and of the addressee to conditions of exchange of documents between them. Although optional in some applications of the invention, this operation allows legal conditions to be satisfied which make possible the certification of some of the document exchanges between the transmitter and the addressee.

This operation can be carried out in the conventional manner by using a form of the click-wrap type, that is to say the transmitter checks a pre-checked box for the addressee, which is equivalent to acceptance of the conditions defined by the text associated with that box. Other methods can also be envisaged.

Once these operations have been completed, registration of the transmitter on the portal 10 finishes at 2240 with the provision of an application which will permit integration in the transmitter system 6.

Provision of the application at 2240 can preferably be carried out by the provision of a hypertext link which allows the operation to be downloaded, or by sending an e-mail containing such a link, or by any other means.

In the embodiment described, the application in question is a virtual print pilot which will enable the transmitter to send a document from a software program on the transmitter system 6 to the exchange unit 12.

This is particularly practical because almost all computer programs have a print option, whatever the operating system.

Accordingly, implementation by a virtual print pilot permits easy integration without the need for particular development for each software program.

The virtual print pilot functions as follows. The transmitter creates the document he wishes to exchange in the desired software program and prints it using the virtual print pilot.

The pilot, instead of trying to print on a physical printer, transmits the print data flow to the reception interface of the exchange unit 12 for processing by that unit.

In a first variant, the transmission of the data by the virtual printer is direct, that is to say the print pilot contains the physical address (URL) of the exchange unit 12 as well as identification codes where necessary.

In another variant, the virtual print pilot communicates with a secure web service, which transmits the transmitter document data 16 to the exchange unit 12. This second variant allows the security of the communications to be increased by imposing an intermediary between the transmitter system 4 and the exchange unit 12.

Although the embodiment described above exhibits “direct” communication between the transmitter system 4 and the exchange device 6, other variants are possible in which an intermediary is placed between them.

Furthermore, in other embodiments, specific integration means are generated and managed by the installed application, such as the creation of a network directory which corresponds to the exchange unit 12 or others.

Accordingly, in the case where the transmitter uses a remote EDI system, the transmitter transmits data to the remote system, which converts them into EDI data as desired by the transmitter. The transmitter is then able to configure the EDI system to transfer the generated EDI data to the device 6 instead of a direct transfer.

In a variant, modules (or plug-ins) can be developed for integration into the software programs for which exchange is desired, or modules can be developed for the operating systems of the transmitter systems in order to launch communication by pressing a key combination or a specific icon.

FIG. 5 shows a particular implementation of the installation operation of operation 2200. The transmitter begins at 2250 by receiving the application from stage 2240, with the installation thereof on the transmitter system 4.

Once the application has been installed, or when the transmitter was already registered and therefore had already installed the application, the installation program invites the transmitter to open the software program which generates the documents that he wishes to exchange with the addressee at 2260. It must be understood that the invention is applicable to any type of software program envisaged for the exchange of transaction documents.

A loop then begins, in which the transmitter will send to the exchange unit a number of master documents which will serve as models for the conversion of subsequent documents.

This loop begins at 2270 with the selection and printing of a test document on the virtual printer in the application.

At 2280, the exchange unit 12 receives the data flow of the transmitter model document and attempts to associate it with other model transmitter documents in the storage device 19.

When such a document is found, a return page is displayed, permitting validation of correspondency with the existing model. The transmitter can then validate that correspondency at 2290.

In a variant, the validation of step 2290 can be carried out by an operator from the exchange unit side 12.

If a corresponding model document is not found, or if correspondency with the model is incomplete, retro-information is effected at 2300 by the transmitter in order to create a new model which better corresponds to the master document. The loop then resumes at 2270 in order to test the new model which has been prepared.

Once the associated model document has been validated at 2290, it is stored in the storage device 19 in correspondence with a transmitter identifier, for example the account identifier established on the portal 10, or another identifier which is sent to him.

The transmitter then indicates in an operation 2310 if further master documents are to be integrated. If so, the loop resumes at 2270 with one of those documents. Otherwise, the storage device 28 is updated in order to indicate that the transmitter is now associated with the addressee (for example by a link in a database table), in an operation 2320, and the installation is terminated at 2330.

In the case where the exchange of documents is dependent on the purchase of credits by the transmitter and/or the addressee, the installation of the application can include the offer for sale of credits and/or the provision of free credits to begin.

FIG. 6 shows an example of the execution of operation 310, that is to say the exchange of a document between a transmitter and an addressee.

The exchange begins at 3100 with the printing, in the transmitter system, of a document to be exchanged on the virtual printer associated with the exchange device 6.

The data flow is transmitted by the web service to the controller 14 by means of the network, and the network transmits it to the converter 15 which, at 3110, analyses the contents of the flow in order to determine the addressee and the transmitter.

This determination can be carried out on the basis of the analysis of the contents of the flow, or it can be based on the transmission of identifiers of the transmitter and of the addressee which can be interpreted by the exchange unit 12.

Once those elements have been determined, the converter 15 interrogates the storage device 28 in order to determine, at 3120, if there is a relation in the storage device between the transmitter and the addressee. In concrete terms, this corresponds to determining whether the operations described in the preceding figures have been carried out and whether there consequently exist transmitter document and addressee document models.

If there is no correspondency, an error function is called at 3130, which can invite the addressee to register in order to exchange documents with the transmitter.

If there is correspondency, the converter 15 continues its analysis of the document received from the transmitter in order to determine the text fields that it contains and to classify them at 3140 on the basis of the transmitter document models taken from the storage device 19.

At 3150, the converter 15 then associates the fields determined at 3140 with compulsory fields laid down during the definition of the needs of the addressee.

At 3160, the converter 15 verifies whether the fields are sufficient to appropriately define an exchange document. If not, the error function 3130 is called in order to indicate this.

If the compulsory fields are present, the converter 15 generates the intermediate document 18, which is transmitted by the controller 14 to the generator 20. The intermediate document 18 serves as an information carrier for processing by the generator 20. The intermediate document 18 contains the transmitter and addressee identifiers, which simplifies the remainder of the operation.

The generator 20 calls the storage device 26 at 3180 in order to determine the addressee's format/model, and generates and sends the addressee document 22 so formatted at 3200.

Subsequently, or in parallel, the generator also generates a control copy or archive document 24 according to the specification defined by the addressee in agreement with the transmitter during the preparation and installation steps.

Optionally, the archive document 24 can be certified or otherwise authenticated prior to being stored, for example by marking. The format of the archive document 24 can also be dictated at least partly by requirements for certification validity.

It must be understood that the archive document 24 can further include several copies of documents which give proof of the transaction. In the example described here, although reference is made to a single storage document 24, that document 24 actually includes a copy of the addressee document 22 and a copy of the transmitter document 16.

Archiving of the addressee document 22 and of the transmitter document 16 allows disputes to be managed more simply because it provides a trusted third party with a copy of the documents received/transmitted by the parties.

In other embodiments, archiving can be carried out with other formats.

Finally, this operation ends at 3210, and a copy of the archive document 24 is transmitted by the interface 13 to the two parties in order to inform them that the transaction has been successful. In a variant, a message can be sent.

The solution described above is particularly valuable because it offers very pronounced decoupling of the document formats for the transmitter and addressee systems. Each party is in fact able to transmit and receive a transaction document in a format that is specific to him.

This is particularly advantageous within the context of international transactions, which may require high specificity on each side in order to be authenticated.

On the other hand, by freeing the parties from the constraints of formats linked to the transaction documents which are being exchanged, the invention makes it possible to provide a global exchange platform.

All the participants from the same industry can be on that platform, whether they be distributors or sellers, without any adaptation of their respective computer information systems being necessary.

In the above, it will be understood that all the variants can be combined with one another in so far as they are compatible. Although preferred embodiments have been described, it goes without saying that the invention covers the totality of those variants and their combinations.

1. Device for exchanging documents between two parties through a network, characterized in that it comprises:
an interface (13) arranged for receiving transmitter document data (16) coming from the network and including at least a transmitter identifier and an addressee identifier,
a converter (15) capable of converting transmitter document data (16) into intermediate document data (18) on the basis of a transmitter model associated with the transmitter identifier of the transmitter document data (16), while keeping the transmitter identifier and the addressee identifier,
a generator (20) capable of converting intermediate document data (18) on the one hand into addressee document data (22) on the basis of an addressee model associated with the addressee identifier of the intermediate document data (18), and on the other hand into archive document data (24), and
a controller (14) arranged for calling the converter (15) with transmitter document data (16) received by the interface, for calling the generator (20) with the resulting intermediate document data, and for storing the resulting archive document data for later access by the transmitter or the addressee.

2. Device according to claim 1, characterized in that it comprises means for marking the archive document data (24).

3. Device according to claim 1, characterized in that the archive document data (24) include a copy of the transmitter document data (16) and a copy of the addressee document data (22).

4. Device according to claim 1, characterized in that the generator (20) is arranged for determining correspondency between the transmitter identifier and the addressee identifier.

5. Device according to claim 4, characterized in that the generator (20) is arranged for generating the addressee document data (22) and the archive document data (24) on the basis of the correspondency between the transmitter identifier and the addressee identifier.

6. Device according to claim 1, characterized in that it comprises a transmitter model storage memory (19).

7. Device according to claim 1, characterized in that it comprises an addressee model storage memory (28).

8. Device according to claim 1, characterized in that it further comprises a portal (10) associated with the addressee system (8), and in that the portal (10) is arranged for providing an application permitting the sending of transmitter document data (16).

9. Device according to claim 8, characterized in that said application is a virtual print pilot.

10. Method of exchanging documents between two parties through a network, characterized in that it comprises:
a) the sending by one party (4) of transmitter document data (16) to an exchange device (6) through the network,
b) the receipt in the exchange device (6) of the transmitter document data (16), which include at least a transmitter identifier and an addressee identifier,
c) the conversion, in the exchange device (6), of the transmitter document data (16) into intermediate document data (18) on the basis of a transmitter model associated with the transmitter identifier of the transmitter document data (16), while keeping the transmitter identifier and the addressee identifier,
d) the conversion, in the exchange device (6), of the intermediate document data (18) into addressee document data (22) on the basis of an addressee model associated with the addressee identifier of the intermediate document data (18), the addressee document data (22) to the addressee, and
e) the conversion, in the exchange device (6), of the intermediate document data (18) into archive document data (24), and storage of the archive document data (24) in the exchange device (6), and
f) the sending, by the exchange device (6), of the addressee document data (24) to the addressee (8).
